(19) United States
(12) Patent Application Publication
(10) Pub. No.: US 2026/0105665 A1
(43) Pub. Date: Apr. 16, 2026

(54) METAL ARTIFACT REDUCTION METHOD IN IMAGE DOMAIN FOR SPECTRAL CT

(71) Applicant: Capital Medical University, Beijing (CN)

(72) Inventors: Dan WANG, Beijing (CN); Zhi YANG, Beijing (CN); Zhe SHI, Beijing (CN)

(21) Appl. No.: 18/879,375

(22) PCT Filed: Nov. 5, 2024
(86) PCT No.: PCT/CN2024/129808

§ 371 Date: Dec. 27, 2024

(30) Foreign Application Priority Data
Oct. 12, 2024 (CN) 202411425932.0

(51) Int. Cl. G06T 11/00; G06T 7/11; G06T 7/136

(52) U.S. Cl. CPC G06T 12/10; G06T 7/11; G06T 7/136; G06T 2207/10081; G06T 2207/20081; G06T 2210/41; G06T 2211/441

(57) ABSTRACT

The present invention provides a metal artifact reduction method in an image domain for spectral CT, and belongs to the technical field of CT imaging. During imaging of a target (e.g., a patient) with a metal implant, metal artifacts can be observed in virtual monoenergetic images obtained by current devices, in particular, it is more obvious at a low energy (low keV). According to the method, by extraction of non-artifact regions (or low-artifact regions) in the virtual monoenergetic images in which artifacts exist and decomposition of basis materials, a relational model between basis materials and artifact-free (or low-artifact) images is constructed, then pixel (voxel) CT values in the artifact-free monoenergetic images corresponding to artifact regions in the above images with artifacts are substituted into the above relational model, and new decomposition of the basis materials is acquired, so that virtual monoenergetic images after artifact correction under arbitrary energy are synthesized.

### FIELD OF TECHNOLOGY

The present invention belongs to the technical field of CT imaging, and in particular, relates to a metal artifact reduction method for virtual monoenergetic images in an image domain for spectral CT.

### BACKGROUND

Metal artifacts are one of the main artifacts of clinical computed tomography (CT), and will degrade projection image quality. The causes of the metal artifacts include beam hardening, scattering, and photon starvation. The existing metal artifact reduction methods can be generally divided into several categories. In terms of a scanning manner, high-voltage scanning can be used. In terms of algorithms, there are typical methods, such as normalized metal artificial reduction (NMAR), etc. The core of such algorithm is projection and interpolation. Optimization may be performed in combination with a manner such as iteration to obtain better images. With the wide application of deep learning in recent years, the deep learning method also has certain applications in metal artifact reduction. In addition, virtual monoenergetic images at higher energies of dual-energy CT can effectively reduce the metal artifacts.

Currently, spectral CT can generate spectral images at single energy, i.e., virtual monoenergetic images. The virtual monoenergetic images at higher energies generally have better metal artifact suppression effects, but obvious metal artifacts still exist in the virtual monoenergetic images at lower energies.

With regard to this phenomenon, different manufacturers develop corresponding metal artifact correction algorithms (metal artifact reduction, MAR) for their own CT products, to reduce metal artifacts in virtual monoenergetic images. However, the core of the MAR algorithm is polynomial interpolation, and if the shape of a metal is regular and artifacts are relatively small, the correction effect of the MAR algorithm on the metal artifacts will be significant. On the contrary, for images with irregular metal shapes and relatively complicated distribution of artifacts, the correction effect of MAR will be relatively poor, and even new artifacts can be introduced, such as postoperative pedicle screw implantation CT, postoperative denture implantation cone beam computed tomography (CBCT) or CT.

### SUMMARY

In order to solve the defects existing in the prior art, the present invention provides a metal artifact reduction method in an image domain for spectral CT, which effectively suppresses and reduces metal artifacts in virtual monoenergetic images of any manufacturer on the basis of an image domain.

In order to solve the above problem, the present invention adopts the following technical solution:

A metal artifact reduction method in an image domain for spectral CT, includes the following steps:
acquiring a plurality of virtual monoenergetic images at arbitrary energies, and acquiring a first image and a second image from the virtual monoenergetic images, wherein the first image is a monoenergetic image with significant artifacts, and the second image is a monoenergetic image without artifacts or with relatively small artifacts;
extracting an artifact region and a non-artifact region of the first image, and correspondingly acquiring an artifact region mask and a non-artifact region mask;
extracting an artifact region of the second image and a non-artifact region of the second image based on the artifact region mask and the non-artifact region mask;
selecting two of the virtual monoenergetic images with energy differences for dual-energy decomposition, to obtain at least two kinds of basis material images;
contrasting the non-artifact region mask, to obtain a corresponding artifact-free basis image constituted by non-artifact region pixels or voxels of each of the basis material images;
constructing a relational model between the non-artifact region of the second image and each artifact-free basis image based on the non-artifact region of the second image and each artifact-free basis image;
substituting the artifact region of the second image into the relational model, to acquire a component image about the artifact region on each of the basis material images, i.e., a corrected basis material image; and
synthesizing the corrected basis material image, to acquire spectral images with artifact correction at the arbitrary energies.

In an embodiment, image types of the spectral images include a virtual monochromatic image, a material density image, an effective atomic number image, an electron density image, a virtual non-contrast image, and an iodine image.

In an embodiment, the extracting an artifact region and a non-artifact region of the first image, and correspondingly acquiring an artifact region mask and a non-artifact region mask includes: acquiring the artifact region mask and the non-artifact region mask after performing artifact correction on the first image by using an artifact correction algorithm;
or, acquiring the artifact region mask and the non-artifact region mask after extracting the artifact region and the non-artifact region of the first image, wherein an extraction method for the artifact region and the non-artifact region of the first image includes a metal artifact reduction algorithm based on interpolation reconstruction; and the extraction method further includes a deep learning based MAR algorithm and direct use of deep learning.

In an embodiment, when the artifact region and the non-artifact region of the first image are extracted, a metal threshold is preset by using an image threshold segmentation method, the first image is traversed point by point, a pixel point with a CT value greater than the metal threshold in the first image is set as 1, a pixel point less than the metal threshold is set as 0, a metal region and a non-metal region are segmented according to assignment of pixel points, and the artifact region and the non-artifact region are extracted according to the metal region and the non-metal region.

In an embodiment, the artifact region mask and the non-artifact region mask are obtained by using a threshold segmentation method.

In an embodiment, acquisition manners for the second image include selecting from the virtual monoenergetic images, selecting from adjacent image layers, and acquiring by reconstruction after coarse artifact correction.

In an embodiment, the relational model includes a relational model between CT values and water/bone basis images, a relational model between the CT values and arbitrary basis materials, and a relational model between the spectral images of arbitrary different types.

In an embodiment, energy states of the virtual monoenergetic images include 50 keV, 70 keV, 80 keV, 100 keV, 120 keV, and 140 keV.

In an embodiment, the method is capable of being suitable for using images with metal or without metal in an image sequence and building the relational model to implement correction.

In an embodiment, the method is suitable for artifact reduction of two-dimensional images and three-dimensional images.

In an embodiment, the method is usable for constructing the corresponding relational model for each set of the spectral images, and for pre-constructing a general relational model suitable for use between monoenergetic images and basis material components.

In an embodiment, in the method, a method for constructing the relational model includes polynomial fitting, deep learning, and pattern recognition.

In an embodiment, the relational model in the method is usable for optimized artifact types including metal artifacts, bone artifacts, and water hardening artifacts.

In an embodiment, the relational model in the method is capable of being suitable for non-spectral images.

The present invention has the following beneficial effects:
1. The present invention develops an algorithm, which can effectively suppress and reduce metal artifacts in virtual monoenergetic images of any manufacturer on the basis of an image domain, so that the suppression effect on the metal artifacts in monoenergetic images at lower energies is comparable with the suppression effect at higher energies.
2. The present algorithm does not introduce new artifacts, and the effect of the algorithm is particularly significant for the situation where the artifacts and the metal forms are complex, and the shortcomings of the traditional MAR algorithm (but not limited to MAR) can be remedied.

### BRIEF DESCRIPTION OF THE DRAWINGS

To describe the specific implementations of the present invention more clearly, the following briefly introduces the drawings required for describing the specific implementations. Apparently, the drawings in the following description are some implementations of the present invention, and for those of ordinary skill in the art, other drawings may also be derived according to these drawings without paying any creative labor.

FIG. 1 shows a flowchart of an algorithm of the present invention;

FIG. 2 shows a flowchart example of extracting a complete artifact image;

FIG. 3 shows a schematic diagram of model construction steps;

FIG. 4 shows virtual monoenergetic images of phantom test results;

FIG. 5 shows virtual monoenergetic images of data test results of patients with pedicle screw implantation; and

FIG. 6 shows virtual monoenergetic images of data test results of patients with oral denture implantation.

### DESCRIPTION OF THE EMBODIMENTS

To make those skilled in the art better understand the technical solution of the present application, the present application is described in detail below in conjunction with drawings and specific embodiments.

It needs to be noted that the method for extracting artifacts in the examples of the present invention is MAR, but is not limited to MAR; in addition, the examples of the present invention show that a model between basis materials and CT values is built, and on the basis of an existing result, a relational model between basis materials can also be directly built, and the two are equivalent.

It needs to be noted that the method in the examples of the present invention for using two monoenergetic images of a non-artifact region to create water/bone basis images without artifacts and build a model can be extended to using other images (images with metal or without metal) in an image sequence and building a model, and the two are equivalent.

It needs to be noted that a relational model between CT values and water/bone basis images in the examples of the present invention can be extended to a relational model between CT values and arbitrary basis material images and a relational model between spectral images of arbitrary other different types.

It needs to be noted that the method is suitable for artifact reduction of two-dimensional images, and can also be directly extended and applied to artifact reduction of three-dimensional images.

It needs to be noted that in addition to constructing a correction model of current data with regard to each set of input data, the method can also pre-construct a model relationship between general monoenergetic images and basis material components. In this case, one correction model can be applied to all input data (including but not limited to constructing a general model with regard to different situations such as different scanning sites and the presence or absence of contrast agents).

It needs to be noted that in the method, methods for building or optimizing models include but are not limited to polynomial fitting, deep learning (neural networks), and pattern recognition.

It needs to be noted that the model in the method is usable for optimized artifact types including but not limited to metal artifacts, bone artifacts, water hardening artifacts, etc.

It needs to be noted that the model in the method is not limited to spectral image modeling, and the same modeling can also be performed on non-spectral images. The non-spectral images refer to images at a single energy level obtained by CT scanning, which are generally tissue density images generated according to the attenuation of radiation, e.g., images with water hardening, or images with bone hardening. The spectral images refer to images obtained by scanning with X-rays at a plurality of different energy levels, and these images are generated on the basis of differences in attenuation characteristics of tissues under different X-ray energies.

For ease of understanding, for specific meanings of proper nouns used in the present application, reference is made to a proper noun comparison table:

Proper Noun Comparison Table

| English proper nouns | Chinese proper nouns |
|---|---|
| Image_Best | Image with relatively small artifacts or without artifacts |
| Image_Best_Artifact | Artifact region in Image_Best |
| Image_Best_noArtifact | Artifact-free region in Image_Best |
| ImageMask0 | Non-artifact region mask |
| ImageMask1 | Artifact region mask |
| Image_Worst | Image with significant artifacts |
| imgWater | Water basis image |
| imgWater_noArtifact | Artifact-free region in water basis image |
| imgWater_ArtifactCorrect | Result of corrected artifact region in water basis image |
| imgWater_Correct | Corrected water basis image |
| imgBone | Bone basis image |
| imgBone_noArtifact | Artifact-free region in bone basis image |
| imgBone_ArtifactCorrect | Result of corrected artifact region in bone basis image |
| imgBone_Correct | Corrected bone basis image |
| VMI_{E}_{₁} | Virtual monoenergetic image with energy E₁; |
| VMI_{E}_{₂} | Virtual monoenergetic image with energy E₂; |
| ρ_{w} | Density of water |
| m_{w}(E) | Mass attenuation coefficient value of water |
| m_{b}(E) | Mass attenuation coefficient value of bone |

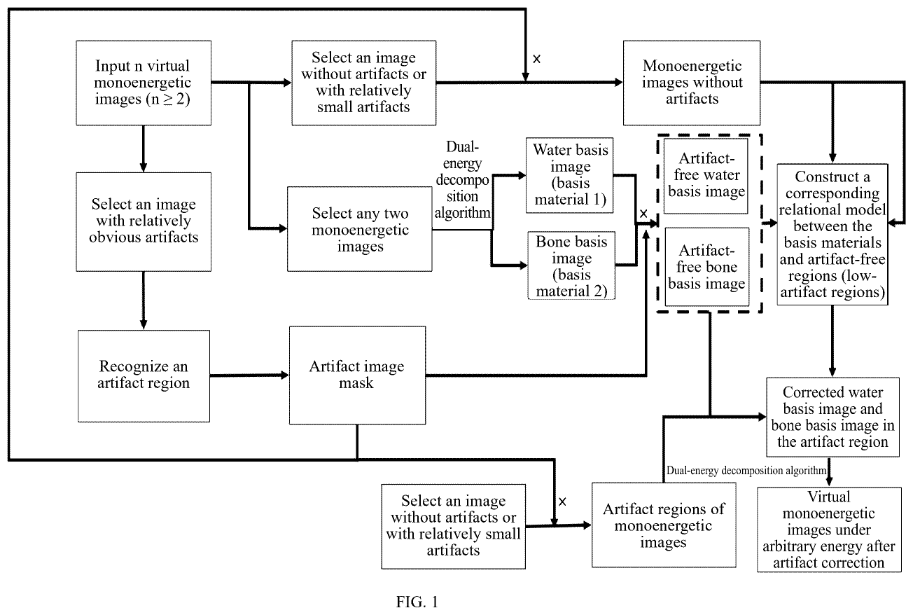

Generally, spectral CT can generate n virtual monoenergetic images of arbitrary energy under an energy of 40 to 140 keV, and it is assumed herein that monoenergetic images output by a product are 6 images in total of 50 keV, 70 keV, 80 keV, 100 keV, 120 keV, and 140 keV. As shown in FIG. 1, the present invention provides a metal artifact reduction method in an image domain for spectral CT, including the following steps:
S1: inputting n virtual monoenergetic images of arbitrary energy, and selecting monoenergetic images with significant artifacts (denoted as Image_Worst), i.e., a first image; and recognizing an artifact region and a non-artifact region existing in the above artifact images.

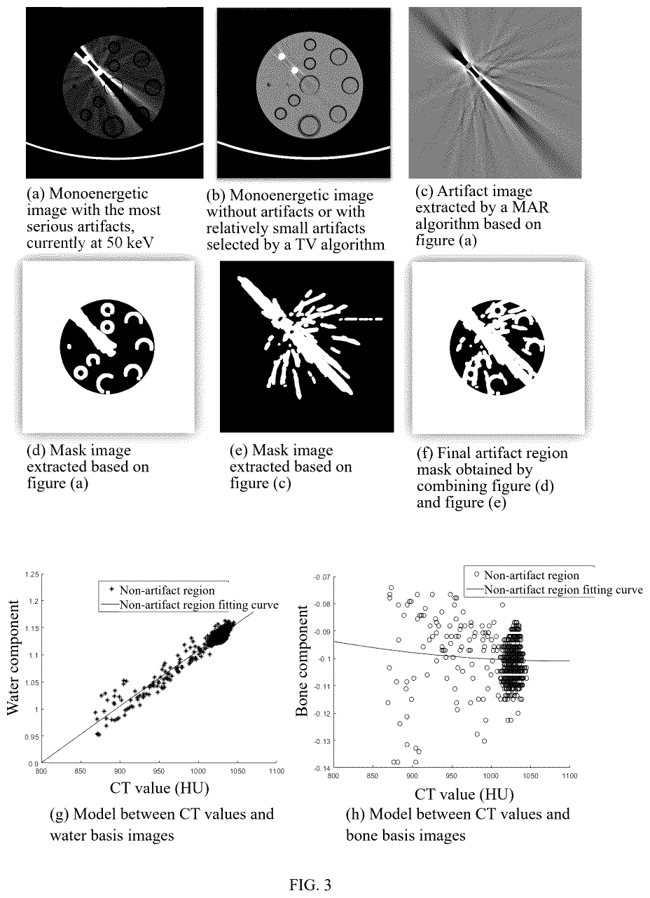

In this embodiment, as shown in FIG. 3(a), Image_Worst is a monoenergetic image of 50 keV, an arbitrary artifact correction algorithm may be used to perform artifact correction on the image to acquire an artifact region mask, or an artifact region or a non-artifact region of the image is directly recognized, the method includes but is not limited to a traditional metal artifact reduction algorithm based on interpolation reconstruction, such as MAR, frequency split metal artifact reduction (fsMAR), iterative metal artifact reduction (iMAR), orthopedic metal artifact reduction (OMAR), and smart metal artifact reduction (sMAR), and it is also not limited to the methods such as a deep learning basis MAR algorithm or direct use of deep learning to recognize the artifact region or the non-artifact region.

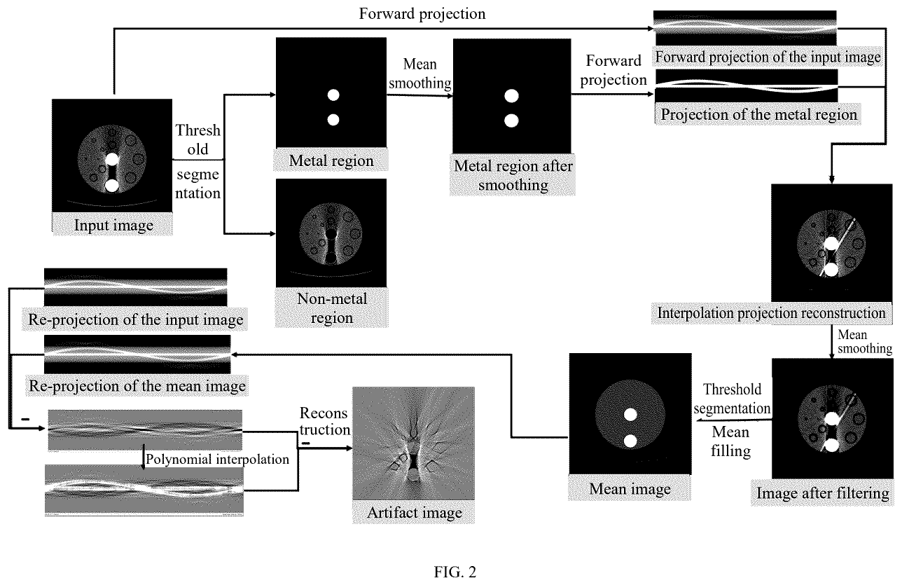

As shown in FIG. 2, a manner for extracting an artifact region is as follows: (1) image threshold segmentation: a metal threshold is set, e.g., Hounsfiled Unit (HU) is 3000, and a HU value is also called a CT value. An image is traversed point by point, a pixel point with an image CT value greater than 3000 is set as 1, and a pixel point with an image CT value less than 3000 is set as 0, so that a metal region and a non-metal region can be divided; (2) performing mean smoothing on a metal image: an operator used in this embodiment is a mean filtering operator with a size of 7×7, and is correspondingly subjected to pointwise multiplication by the image in a sliding window manner, to obtain a slightly enlarged metal region image after smoothing; (3) an input image is subjected to forward projection by using a projection algorithm, at the same time, the metal image is subjected to forward projection, and in projection data, it can be judged according to the positions of projection data of metal that which positions in the projection of an original image are metal regions, and then polynomial interpolation is performed on these regions to obtain corrected projection data; (4) the corrected projection data is reconstructed to obtain a preliminary corrected image; (5) the image is smoothed again by using a mean filtering operator with a size of 7×7; (6) threshold segmentation: in this embodiment, a threshold interval of soft tissues is set to 800 to 1200, a soft tissue region is extracted, and a mean of CT values of the soft tissues is calculated; (7) the soft tissue region except the metal region is filled to obtain a mean image; (8) forward projection is performed on the mean image by using a projection algorithm, projection data of the input image and projection data of the mean image are subjected to subtraction to obtain a difference value denoted as Pjr_diff, polynomial interpolation is performed again on the difference value, and a result is denoted as Pjr_inter; (9) the result of subtracting Pjr_diff from Pjr_inter is reconstructed by using a reconstruction algorithm, to obtain a final artifact region.
S2: acquiring an artifact region mask (denoted as ImageMask1) and a non-artifact region mask (denoted as ImageMask0).

In this embodiment, a selected algorithm is a threshold segmentation method, in which segmentation calculation is performed on an artifact image by using a threshold, and CT values at corresponding positions are added and re-assigned, to obtain the artifact region mask. The threshold segmentation method includes direct threshold segmentation or a threshold segmentation method with certain function distribution, wherein the threshold segmentation method with certain function distribution includes a histogram technique method, an entropy algorithm, an adaptive threshold algorithm, etc.

A threshold selected in this embodiment is −800, which is intended to extract an air region (an air CT value is −1000), an image with significant artifacts (FIG. 3(a)) is segmented and traversed point by point, if it is greater than −800, it is set as 1, if it is less than −800, it is set as 0, and FIG. 3(d) will be obtained. By using the same method, a threshold is set as 100, which is intended to extract a main artifact region, threshold segmentation is performed on an artifact image (FIG. 3(c)) to obtain FIG. 3(e), finally, CT values at corresponding positions in FIG. 3(e) and FIG. 3(d) are added, a point with a CT value of 2 is reset to 1, and a final artifact region mask will be obtained and denoted as ImageMask1 (FIG. 3(f)).
S3: selecting an image without artifacts or with relatively small artifacts (denoted as Image_Best), i.e., a second image, and according to the two masks acquired in S2, obtaining two new images from Image_Best, in which one only contains an image (denoted as Image_Best_Artifact) constituted by pixels or voxels of Image_Best in a mask selection region of ImageMask1, i.e., an artifact region of the second image, and the other one only contains an image (denoted as Image_Best_noArtifact) constituted by pixels or voxels of Image_Best in a mask selection region of ImageMask0, i.e., a non-artifact region of the second image.

It needs to be noted that the image without artifacts or with relatively small artifacts (Image_Best) may be selected from the n virtual monoenergetic images of arbitrary energy in S1, or from images reconstructed in other manners, including but not limited to images reconstructed by other sources (e.g., different image layers, data after coarse artifact correction, etc.) or other manners. The different image layers here refer to adjacent image layers. If a two-dimensional image is corrected, but actual human data is necessarily three-dimensional, image layers without metal artifacts or image layers with relatively small artifacts may be found in a three-dimensional image, and in this case, a current artifact image layer may be corrected by modeling these image layers without artifacts or the image layers with relatively small artifacts. The coarse artifact correction may be using conventional artifact reduction methods, such as MAR, interpolation-based projection data restoration, and iteration-based reconstruction correction.

In this embodiment, Image_Best is selected from the n virtual monoenergetic images of arbitrary energy in S1; as shown in FIG. 3(b), an image without artifacts or with relatively small artifacts in the n input monoenergetic images is automatically recognized by using an algorithm, e.g., a total variation (TV) algorithm. In this embodiment, a cost function of a theoretical TV function is used, and the TV function is as shown in formula (1):

$${u}_{i , j} = \sqrt{{( {f}_{i + 1 , j} - {f}_{i , j} )}^{2} + {( {f}_{i , j + 1} - {f}_{i , j} )}^{2}} \qquad ( 1 )$$

where i, j represents a pixel index of an image, f_{i,j} represents an image pixel value at a position (i,j), and u_{i,j} represents a TV value of one pixel value, wherein a TV value of a current point may be calculated by traversing each pixel point of the image, and finally the TV values of all points are summed to obtain a final TV value of the image.

Cost function values of n images are calculated in sequence, and an image with a minimum cost function value is considered to be the image without artifacts or with relatively small artifacts.

The recognized image without artifacts or with relatively small artifacts is subjected to pointwise multiplication by corresponding positions of the non-artifact region mask ImageMask0, to obtain a non-artifact region (denoted as Image_Best_noArtifact) of the current image, and the image without artifacts or with relatively small artifacts is subjected to pointwise multiplication by the artifact region mask ImageMask1, to obtain an artifact region (denoted as Image_Best_Artifact) of the current image.
S4: selecting, from S1, two of the virtual monoenergetic images with energy differences for dual-energy decomposition, to obtain two or more kinds of basis material images.
S5: contrasting ImageMask0, to obtain an image constituted by non-artifact region pixels or voxels of the two or more kinds of basis material images.

It needs to be noted that there may be n kinds of decomposed basis materials, however, in order to briefly explain the problem, the embodiments shown in the present invention use two kinds of decomposition basis materials, in which a first basis material is a water basis material, a second basis material is a bone basis material, and density images of the water basis material and the bone basis material are respectively multiplied by the non-artifact region mask, to obtain an artifact-free water basis image and an artifact-free bone basis image.

The image without artifacts or with relatively small artifacts (Image_Best) recognized in S3 and the image with significant artifacts (Image_Worst) are used for dual-energy decomposition, to obtain a water basis image (denoted as imgWater) and a bone basis image (denoted as imgBone). A process for dual-energy decomposition is as follows:

$$\{ \begin{matrix}V M {I}_{{E}_{1}} ( {E}_{1} ) = \frac{1000}{{ρ}_{w}} \times i m g W a t e r + \frac{1000}{{ρ}_{w}} \times ( \frac{{m}_{o b j} ( {E}_{1} )}{{m}_{w} ( {E}_{1} )} ) \times i m g B o n e - 1000 \\ V M {I}_{{E}_{2}} ( {E}_{2} ) = \frac{1000}{{ρ}_{w}} \times i m g W a t e r + \frac{1000}{{ρ}_{w}} \times ( \frac{{m}_{o b j} ( {E}_{2} )}{{m}_{w} ( {E}_{2} )} ) \times i m g B o n e - 1000\end{matrix} \qquad ( 2 )$$

where E₁ and E₂ represent two kinds of energies, VMI_{E}_{₁} and VMI_{E}_{₂} correspond to Image_Best and Image_Worst in sequence, ρ_{w} represents the density of water, m_{w}(E) represents a mass attenuation coefficient value of a water material under energy E, and m_{b}(E) represents a mass attenuation coefficient of a bone material under energy E. The mass attenuation coefficient of the water under different energies and the mass attenuation coefficient value of the bone material under different energies are both known, and relevant information may be queried on a public website, and from the equation, a water basis image and a bone basis image may be solved.

Finally, the water basis image and the bone basis image are multiplied by the non-artifact region mask ImageMask0, respectively, and an artifact-free water basis image and an artifact-free bone basis image (denoted as imgWater_noArtifact and imgBone_noArtifact) will be obtained.
S6: constructing a relational model between the Image_Best_noArtifact image and the two or more kinds of basis material images on the basis of the Image_Best_noArtifact image in S3 and the image constituted by non-artifact region pixels or voxels obtained in S5.

On the basis of a CT value of the artifact-free image (Image_Best_noArtifact) and the artifact-free water basis image and the artifact-free bone basis image (imgWater_noArtifact and imgBone_noArtifact), each pixel point of Image_Best_noArtifact, imgWater_noArtifact and imgBone_noArtifact is traversed in sequence, the sizes of the three images are consistent, and a pixel value at the same position is taken out, so that two groups of data pairs may be formed, i.e., CT value-water basis image value and CT value-bone basis image value respectively; that is, a plurality of scatter points are formed and correspond to the scatter point distribution of FIGS. 3(g) and (h), and finally, polynomial fitting is performed on these scatter points, to obtain the fitting curves of FIGS. 3(g) and (h). Thus, the relational model between the CT values and the water/bone basis images is constructed.

It needs to be pointed out that an algorithm is to construct a model of current data to be processed with respect to a certain piece of data, and therefore, a model form is not unique.
S7: substituting the Image_Best_Artifact image obtained in S3 into the relational model built in S6, to acquire a component image about the artifact region on the two or more kinds of basis materials, i.e., a corrected basis material image.

Each pixel point of the artifact region image, i.e., Image_Best_Artifact, obtained in S3 is traversed to obtain a CT value, which is substituted into S6 to build curve fitting formulas in FIGS. 3(g) and (h), and a water basis image value and a bone basis image value (denoted as imgWater_ArtifactCorrect and imgBone_ArtifactCorrect) corresponding to each CT value will be obtained. Finally, imgWater_ArtifactCorrect+imgWater_noArtifact is denoted as imgWater_Correct, and imgBone_ArtifactCorrect+imgBone_noArtifact is denoted as imgBone_Correct.
S8: synthesizing spectral images with artifact correction under the arbitrary energy by the basis material images (imgWater_Correct and imgBone_Correct) obtained in S7.

It needs to be noted that the spectral images include but are not limited to artifact representation in spectral images such as a virtual monochromatic image, a material density image, an effective atomic number image, an electron density image, a virtual non-contrast image, and an iodine image, and the accuracy of spectral decomposition results of a non-image class such as a spectral curve and a scatter plot can also be improved.

In this embodiment, on the basis of imgWater_Correct and imgBone_Correct, dual-energy decomposition is performed again, so that virtual monoenergetic images with artifact correction under arbitrary energy can be obtained. A dual-energy decomposition formula for this time is as follows:

$$VMI ( E ) = \frac{1000}{{ρ}_{w}} \times imgWater\_Correct + \frac{1000}{{ρ}_{w}} \times ( \frac{{m}_{o b j} ( E )}{{m}_{w} ( E )} ) \times imgBone\_Correct - 1000 \qquad ( 3 )$$

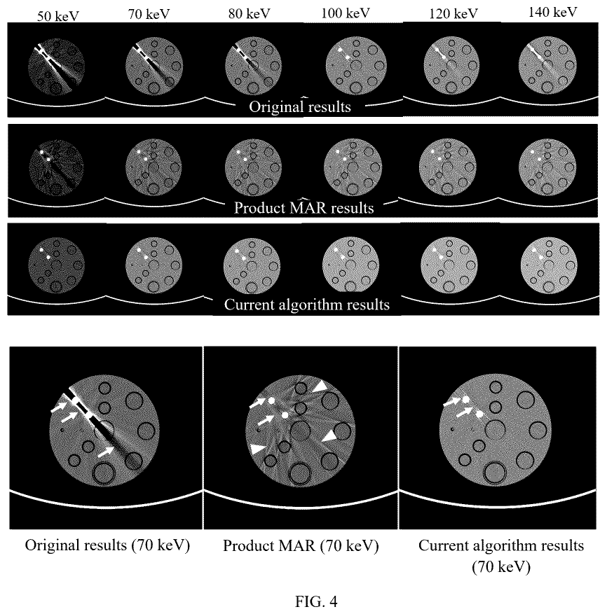

Verification is performed on the above algorithm verification, and verification results are as shown in FIG. 4 to FIG. 6, where an arrow represents an artifact existing in an image itself, an isosceles triangle represents an artifact introduced by a correction algorithm (the correction algorithm includes two kinds, i.e., a traditional MAR algorithm and an algorithm proposed by the present invention respectively) with respect to an original image, and a rectangular frame represents a change in an image structure caused by the correction algorithm with respect to the original image.

Verification Embodiment 1: an independently developed CT performance phantom, having a diameter of 200 mm, and two titanium cylindrical phantoms with a diameter of 10 mm being embedded therein, is placed in dual-energy CT of a certain international well-known manufacturer for scanning.

As shown in FIG. 4, results in a first row are virtual monoenergetic images without MAR correction under different energies provided by manufacturer software, and it can be seen that for monoenergetic images under a low energy, e.g., below 70 keV, obvious artifacts exist between two metals, and the correction effect on artifacts of monoenergetic images under a high energy is relatively good; results in a second row are results of MAR correction performed by the manufacturer software, and it can be seen that the artifacts of the overall images are suppressed to a certain degree, however, many new artifacts are introduced, and meanwhile, the correction effect of the image of 50 keV is not ideal either; a third row shows correction results of the algorithm set forth in the present invention based on the images in the first row, the overall correction effect is superior to the correction effect of the MAR algorithm of the manufacturer, no new artifacts are introduced, and the artifact suppression effect of the algorithm is significant, indicating the effectiveness of the algorithm; a fourth row shows zoomed-in images of the images of 70 keV in the results of the first 3 rows. It can be clearly seen that the proposed algorithm effectively reduces the artifacts of the regions indicated by the arrows without introducing new artifacts.

Verification Embodiment 2: a postoperative CT of a patient with pedicle screw implantation is placed into dual-energy CT of a certain international well-known manufacturer for scanning.

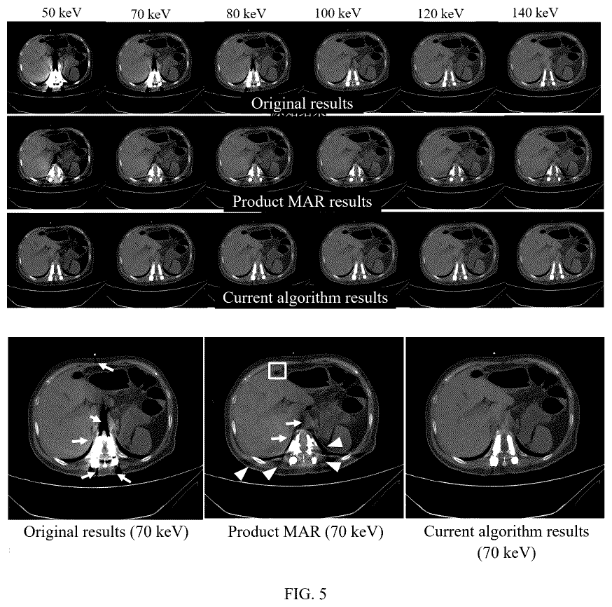

As shown in FIG. 5, similar to FIG. 4, a first row shows original monoenergetic images of the manufacturer, a second row shows monoenergetic images after MAR of the manufacturer, a third row shows correction results of a current algorithm based on the images in the first row, and a fourth row shows zoomed-in images of the images of 70 keV in the results of the first 3 rows; for the product MAR correction results, dark band artifacts (as shown by the isosceles triangle) are obviously introduced, the surrounding of the metal is blurred and unclear, and a change in a tissue structure (as shown by the rectangular frame) is caused. However, the correction of the current algorithm effectively reduces the artifacts of images under all energies, and the metal boundary is clearer.

Verification Embodiment 3: a postoperative CT of a patient with oral denture implantation is placed into dual-energy CT of a certain international well-known manufacturer for scanning.

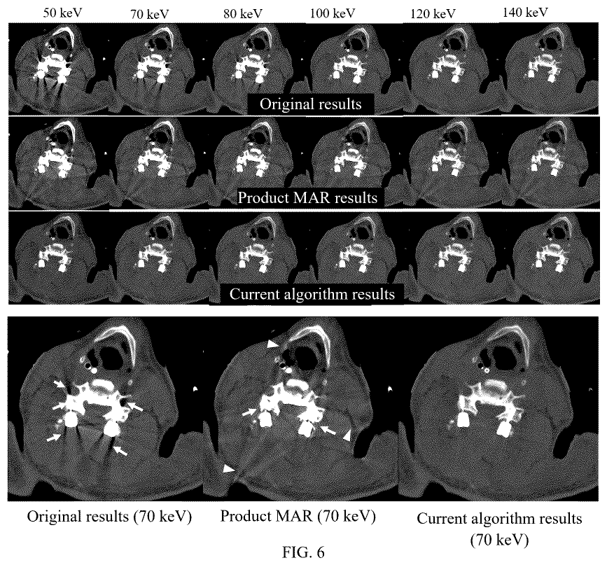

As shown in FIG. 6, similarly, a first row shows original monoenergetic images of the manufacturer, a second row shows monoenergetic images after MAR of the manufacturer, a third row shows correction results of a current algorithm based on the images in the first row, and a fourth row shows zoomed-in images of the images of 70 keV in the results of the first 3 rows; for the product MAR correction results, although the artifacts in the original images are reduced, many new artifacts are introduced at the same time. The current correction algorithm is significantly superior to the product MAR results, no new artifacts are introduced, and meanwhile, the artifacts in the low-keV images are also effectively reduced.

The present invention is described in detail through the embodiments above, but the described contents are only the preferred embodiments of the present invention, and cannot be considered as limiting the scope of implementation of the present invention. Any equivalent variation and improvement made according to the application scope of the present invention shall fall within the scope of protection of patent of the present invention.

1. A metal artifact reduction method in an image domain for spectral CT, comprising the following steps:
acquiring a plurality of virtual monoenergetic images at arbitrary energies, and acquiring a first image and a second image from the virtual monoenergetic images, wherein the first image is a monoenergetic image with significant artifacts, and the second image is a monoenergetic image without artifacts or with relatively small artifacts;
extracting an artifact region and a non-artifact region of the first image, and correspondingly acquiring an artifact region mask and a non-artifact region mask;
extracting an artifact region of the second image and a non-artifact region of the second image based on the artifact region mask and the non-artifact region mask;
selecting two of the virtual monoenergetic images with energy differences for dual-energy decomposition, to obtain at least two kinds of basis material images;
contrasting the non-artifact region mask, to obtain a corresponding artifact-free basis image constituted by non-artifact region pixels or voxels of each of the basis material images;
constructing a relational model between the non-artifact region of the second image and each artifact-free basis image based on the non-artifact region of the second image and each artifact-free basis image;
substituting the artifact region of the second image into the relational model, to acquire a component image about the artifact region on each of the basis material images, i.e., a corrected basis material image; and
synthesizing the corrected basis material image, to acquire spectral images with artifact correction at the arbitrary energies.

2. The metal artifact reduction method in an image domain for spectral CT according to claim 1, wherein image types of the spectral images comprise a virtual monochromatic image, a material density image, an effective atomic number image, an electron density image, a virtual non-contrast image, and an iodine image.

3. The metal artifact reduction method in an image domain for spectral CT according to claim 1, wherein
the extracting an artifact region and a non-artifact region of the first image, and correspondingly acquiring an artifact region mask and a non-artifact region mask comprises: acquiring the artifact region mask and the non-artifact region mask after performing artifact correction on the first image by using an artifact correction algorithm;
or, acquiring the artifact region mask and the non-artifact region mask after extracting the artifact region and the non-artifact region of the first image, wherein an extraction method for the artifact region and the non-artifact region of the first image comprises a metal artifact reduction algorithm based on interpolation reconstruction; and the extraction method further comprises a deep learning based MAR algorithm and direct use of deep learning.

4. The metal artifact reduction method in an image domain for spectral CT according to claim 3, wherein when the artifact region and the non-artifact region of the first image are extracted, a metal threshold is preset by using an image threshold segmentation method, the first image is traversed point by point, a pixel point with a CT value greater than the metal threshold in the first image is set as 1, a pixel point less than the metal threshold is set as 0, a metal region and a non-metal region are segmented according to assignment of pixel points, and the artifact region and the non-artifact region are extracted according to the metal region and the non-metal region.

5. The metal artifact reduction method in an image domain for spectral CT according to claim 1, wherein the artifact region mask and the non-artifact region mask are obtained by using a threshold segmentation method.

6. The metal artifact reduction method in an image domain for spectral CT according to claim 1, wherein acquisition manners for the second image comprise selecting from the virtual monoenergetic images, selecting from adjacent image layers, and acquiring by reconstruction after coarse artifact correction.

7. The metal artifact reduction method in an image domain for spectral CT according to claim 1, wherein the relational model comprises a relational model between CT values and water/bone basis images, a relational model between the CT values and arbitrary basis materials, and a relational model between the spectral images of arbitrary different types.

8. The metal artifact reduction method in an image domain for spectral CT according to claim 1, wherein energy states of the virtual monoenergetic images comprise 50 keV, 70 keV, 80 keV, 100 keV, 120 keV, and 140 keV.

9. The metal artifact reduction method in an image domain for spectral CT according to claim 1, wherein the method is capable of being suitable for using images with metal or without metal in an image sequence and building the relational model to implement correction.

10. The metal artifact reduction method in an image domain for spectral CT according to claim 1, wherein the method is suitable for artifact reduction of two-dimensional images and three-dimensional images.

11. The metal artifact reduction method in an image domain for spectral CT according to claim 1, wherein the method is usable for constructing the corresponding relational model for each set of the spectral images, and for pre-constructing a general relational model suitable for use between monoenergetic images and basis material components.

12. The metal artifact reduction method in an image domain for spectral CT according to claim 1, wherein in the method, a method for constructing the relational model comprises at least one of polynomial fitting, deep learning, and pattern recognition.

13. The metal artifact reduction method in an image domain for spectral CT according to claim 1, wherein the relational model in the method is usable for optimized artifact types comprising at least one of metal artifacts, bone artifacts, and water hardening artifacts.

14. The metal artifact reduction method in an image domain for spectral CT according to claim 1, wherein the relational model in the method is capable of being suitable for non-spectral images.
